(19) United States
(12) Patent Application Publication
(10) Pub. No.: US 2009/0228297 A1
(43) Pub. Date: Sep. 10, 2009

(54) Employment Systems Using Resume Posting and Reporting Standard

(75) Inventors: Robert McGovern, Potomac, MD (US); Richard Ellinger, Great Falls, VA (US); Erik Anderson, Olney, MD (US); Matthew Hagopian, Arlington, VA (US); Brent Smith, Oak Hill, VA (US)

Correspondence Address: K&L Gates LLP, P.O. BOX 1135, CHICAGO, IL, 60690, US

(73) Assignee: JOBFOX, INC., McLean, VA (US)

(21) Appl. No.: 12/415,567

(22) Filed: Mar. 31, 2009

Related U.S. Application Data
(63) Continuation-in-part of application No. 11/331,672, filed on Jan. 13, 2006.
Application No. 11/331,672 is a continuation-in-part of application No. 11/104,142, filed on Apr. 11, 2005.

(51) Int. Cl. G06Q 10/00

(52) U.S. Cl. 705/1

(57) ABSTRACT

A portable resume system and method collects and stores a user's credentials/attributes (e.g., a job seeker's resume information, skills, or any other suitable data) in a standardized format that can be shared with any individual, entity, or system to streamline the process of applying for jobs. Certain portions of the portable resume system function as a clearinghouse or portfolio for the user's credential's/attributes and enable the user to share any or all of the user's stored data with a plurality of different destinations (e.g., job applicant tracking systems (ATS), online job databases, employment websites, employers, recruiters, individuals, etc. . . . ). If the user shares the user's stored data with a destination that supports the portable resume system, the user can bypass at least part of or all of the destination's registration process. The portable resume system also enables the destination to obtain any updates the user makes to the user's stored data.

### PRIORITY CLAIM

This application is a continuation-in-part of, claims the benefit of and priority to U.S. patent application Ser. No. 11/104,142, filed on Apr. 11, 2005, and U.S. patent application Ser. No. 11/331,672, filed on Jan. 13, 2006, the entire contents of which are incorporated herein by reference.

### BACKGROUND

An employment system is any electronic system which facilitates those looking for a position (i.e., employment seekers, or job seekers) in finding a position and/or which facilitates those seeking to fill a position (i.e., employee seekers, or employers) in finding someone to fill the position. Typical employment systems enable employers to post available positions, and further enable job seekers to search available positions for positions that meet some search criteria. Some employment systems enable job seekers to post a resume, and further enable employers to search for resumes that contain certain keywords. However, traditional employment systems are inefficient for many reasons.

Employers have difficulty finding desirable candidates for positions by searching resumes on an employment site because information is not necessarily presented in a uniform manner for each resume. Typically, an employer enters one or more keywords and the database of job seeker resumes are searched to determine which resumes contain the keywords. Similarly, job seekers enter keywords upon which the database of available jobs are searched. Thus, if an ideal job seeker leaves pertinent information (e.g., language experience, a certification, security clearance level, etc.) out of a resume or even puts the information into the resume without using the keywords searched upon (e.g., using synonyms or containing a typo), the employer may never find the ideal job seeker's resume. Boolean searches (searches using keywords and/or strings that can be resolved to truth values in addition to Boolean operators such as AND, OR and NOT) may provide improved search results, but still suffers from the same problem. Further, a keyword and/or Boolean search may generate many false-positive results because the keyword is present in a resume but not in the correct context. Such false-positive results waste the potential employer's time.

Further, if a potential employer finds a resume that appears ideal, the first indication the employer may receive that information in the resume is inaccurate is when the employer contacts or interviews the job seeker, or even after the job seeker is hired. By the time the potential employer discovers the inaccuracy, considerable time and effort has been wasted.

In employment systems in which potential employers post available positions, potential employers are often inundated with resumes from unqualified job seekers. Some job seekers submit their resume to any position they find desirable, regardless of whether they meet any specified required qualifications on the hope that they will either be the most qualified applicant or that they will be qualified enough to get an interview and perhaps gain employment as a result.

Because unqualified job seekers submit their resumes, potential employers must sift through the submitted resumes to find the qualified applicants, which is an inefficient use of their time. Further, if the ratio of resumes from qualified applications to resumes from unqualified applicants becomes small, the potential employer may disregard all resumes from the employment system and discontinue further use of the employment system.

Another inefficiency of many employment systems is that they do not offer guidance to both job seekers and potential employers on improving their use of the employment system. As a result, an employer may be unaware that a much broader pool of qualified job seekers may be available if some conditions of the position were altered. Similarly, a job seeker may be unaware that a broader pool of positions may be available if they alter the conditions of their job search.

Furthermore, each job board and employer website are generally isolated and a job seeker must visit each job board and company website in which the employment seeker is interested. This has several drawbacks. First, job seekers must enter their information in countless websites. This can cause the job seekers to abandon their efforts on many websites and/or neglect to fill out all of the pertinent information, leading to inaccurate data compilation and wasted time for employers. Second, job seekers may not be aware of all employers seeking someone having the job seeker's skills and/or experience. Thus, a prospective employer and the job seeker will be ignorant of each other and never properly matched.

### SUMMARY

A portable resume system and method collects and stores a user's credentials/attributes (e.g., a job seeker's resume information, skills, desires, or any other suitable data) in a standardized format that can be shared with any individual, entity, or system to streamline the process of applying for jobs. Certain portions of the portable resume system function as a clearinghouse or portfolio for the user's credential's/attributes and enable the user to share any or all of the user's stored data with a plurality of different destinations (e.g., job applicant tracking systems (ATS), online job databases, employment websites, employers, recruiters, individuals, etc. . . . ). If the user shares the user's stored data with a destination that supports the portable resume system, the user can bypass at least part of or all of the destination's registration process, if applicable. The portable resume system also enables the destination to obtain any updates the user makes to the user's stored data. Thus, the portable resume system enables the user to provide the user's stored data to different destinations without having to recreate or modify the user's data at each of the different destinations.

In one embodiment, a portable resume system includes at least one terminal in communication with at least one network, and at least one resume server in communication with the at least one network and configured to store resume data. The at least one terminal and the at least one resume server are configured to communicate over the at least one network to (i) capture a plurality of resume data for at least one user at the at least one terminal, (ii) upload the captured plurality of resume data to the resume server, (iii) store the uploaded plurality of resume data, and (iv) generate a resume in a predefined resume format based at least in part on the stored resume data.

In one embodiment, the at least one terminal and the at least one resume server are configured to enable at least one destination to obtain and store the generated resume. In one embodiment, the at least one destination includes at least one job server configured to pull the generated resume. In an alternative embodiment, the resume server is configured to push the generated resume to the at least one destination. In one embodiment, the at least destination job server maps at least a portion of the data from the generated resume to at least a portion of the at least one destination's predefined resume language. In another embodiment, if the user modifies any of the captured resume data or adds new resume data, the destination job server can obtain and store the updated or new resume data. In one embodiment, the resume server pushes the new or updated resume data to the destination job server. In an alternative embodiment, the destination job server pulls the new or updated resume data from the resume server.

In one embodiment of the system, if the at least one destination job server obtains the generated resume as an application for a first job opening, the at least one destination job server automatically compares the generated resume to at least one different job opening. In another embodiment of the system, captured resume data is at least partially in a standardized resume language. In yet another embodiment of the system, the at least one terminal generates a resume in the predefined resume format based at least in part on the captured resume data.

In one embodiment, a method for distributing a portable resume includes (a) capturing a plurality of resume data for at least one user with at least one terminal that is in communication with at least one network, (b) uploading the captured plurality of resume data to a resume server that is in communication with the at least one network, (c) storing the uploaded plurality of resume data in the resume server, and (d) generating a resume in a predefined resume format based at least in part on the resume data stored in the resume database.

In one embodiment, the method further comprises providing at least one destination access to the generated resume stored in the resume server. In an alternative embodiment, the method comprises storing the generated resume based on the predefined resume format in at least one destination job server. In yet another embodiment, the method comprises translating at least a portion of the generated resume data stored in the at least one destination job server to a second predefined resume format used by the at least one destination job server based on a data mapping between resume data in the predefined resume format and the second predefined resume format.

In one embodiment, the method includes enabling the at least one destination job server to obtain any newly added or updated resume data associated with the generated resume. In an alternative embodiment of the method, the resume server pushes the new or updated resume data to the destination job server. In another alternative embodiment of the method, the destination job server pulls the new or updated resume data from the resume server.

In one embodiment of the method, if the destination job server obtains the generated resume as an application for a first job opening, the method further includes automatically comparing the generated resume to at least one different job opening. In one embodiment of the method, the captured resume data is at least partially in a standardized resume language.

Additional features and advantages are described herein, and will be apparent from the following Detailed Description and the figures.

### BRIEF DESCRIPTION OF THE FIGURES

FIG. 1 illustrates a flow diagram of a method of sharing a user's data in accordance with one embodiment.

FIG. 2 illustrates a flow diagram of a method of generating a resume in a predefined resume format in accordance with one embodiment.

FIG. 3 illustrates a system diagram of a resume system for generating and distributing a resume in a predefined resume format in accordance with one embodiment.

### DETAILED DESCRIPTION

The present invention relates to a portable resume system and method that collects and stores a user's credentials or attributes (e.g., a job seeker's resume information, skills, desires, or any other suitable data) in a standardized format that can be shared with any individual, entity, or system to streamline the process of applying for jobs. Certain portions of the portable resume system function as a clearinghouse or portfolio for the user's credential's/attributes and enable the user to share any or all of the user's stored data with a plurality of different destinations (e.g., job applicant tracking systems (ATS), online job databases, employment websites, employers, recruiters, individuals, etc. . . . ). If the user shares the user's stored data with a destination that supports the portable resume system, the user can bypass at least part of or all of the destination's registration process (as is typically required by online job databases and ATSs), if applicable. The portable resume system also enables the destination to obtain any updates the user makes to the user's stored data. Thus, the portable resume system enables the user to provide the user's stored data to different destinations without having to recreate or modify the user's data at each of the different destinations.

In one embodiment, the portable resume system creates resumes based on a predefined resume format, wherein the predefined resume format includes resume data in a standardized resume language. The portable resume system allows a user to create a resume in a predefined resume format and distribute the resume to a plurality of different destinations (e.g., employment/job websites, employers and/or employer job servers, recruiters, etc. . . . ). If the destinations receiving the resume have a system designed to interoperate with the portable resume system (e.g., support and process the resume in the predefined resume format or process the user's data if provided in a different manner), the user can easily distribute the same resume to each of the destinations supporting the portable resume system without having to recreate or modify the resume for each of these destinations. The portable resume system also allows the user to automate distribution of any additions or updates the user makes to the user's resume data to any destination that previously received the user's resume data. Thus, it should be appreciated that the portable resume system allows a plurality of different destinations that support the portable resume system to obtain the user's resume data without requiring the user to work through a plurality of registration processes or create a different resume for each of a plurality of different destinations. It should also be appreciated that the portable resume system allows the user to update the user's resume data once and make the updates available to a plurality of the different destinations that previously received the resume data without requiring the user to contact each of the plurality of different destinations individually to update the resume data.

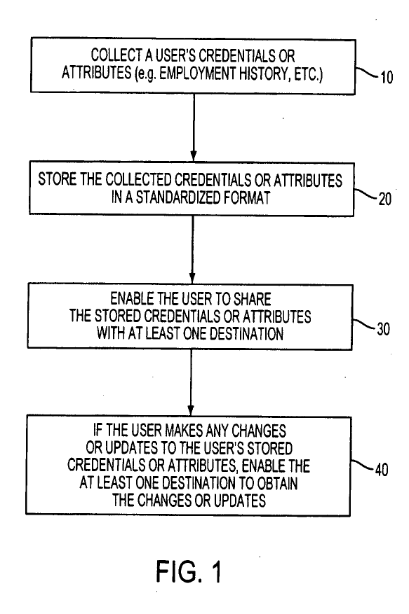

FIG. 1 is a flow diagram illustrating one method of operating a portable resume system that enables a user to share the user's stored credentials/attributes with at least one destination. At block 10, the portable resume system collects a user's credentials or attributes (i.e., the user's data). In one embodiment, the portable resume system collects at least a portion of the user's credentials or attributes through a question and answer process. As illustrated at block 20, the portable resume system stores any of the collected user credentials or attributes in a standardized format. For example, the portable resume system enables the user to select answers to the questions using standardized (i.e., predefined) language that describe the user's attributes (e.g., employment history, skills, any other suitable information).

As illustrated in block 30, the portable resume system enables the user to share the user's stored credentials or attributes with at least one destination. For example, the portable resume system enables the user to transmit the stored credentials or attributes to an ATS or a job server that collects resumes or other similar user data. In an alternative example, the portable resume system enables the user to authorize a destination to obtain the user's stored credentials or attributes. It should be appreciated that the user's stored credentials or attributes can be made available to any desired destination. At block 40, if the user makes any changes or updates to the user's stored credentials or attributes, the portable resume system enables the at least one destination to obtain the user's changes or updates. That is, in one embodiment, the user can cause the portable resume system to transmit the updates to any destination that received the user's stored credentials or attributes. Alternatively, any destination can request or check for any updates to the user's stored credential or attributes based on a user's authorization to access the data.

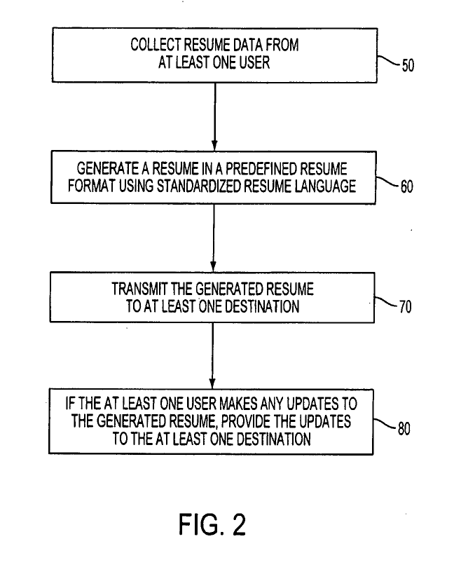

FIG. 2 is a flow diagram illustrating one method of operating a portable resume system that stores a user's resume data in a standardized resume language and can generate a resume in a predefined resume format with the standardized resume language. At block 50, the portable resume system collects resume data from at least one user. In one embodiment, the portable resume system collects at least a portion of the user's resume data through a question and answer skills interview process. In one such embodiment, the system enables the user to select answers to the questions using standardized (i.e., predefined) resume language that describe the user's attributes (e.g., employment history, skills, any other suitable information). As illustrated at block 60, the portable resume system generates a resume in the predefined resume format using standardized resume language based on the resume data collected from the at least one user. In one embodiment, the portable resume system generates the resume in the predefined resume format by associating or marking at least some of the collected resume data in the generated resume as a particular type of data. For example, the portable resume system may associate a university name that the user attended as “university name.” Thus, a computer configured to parse the predefined resume format will know that the portion of the generated resume with the university name is associated with a school the user attended. It should be appreciated that any suitable data structure can be used to associate, mark, or tag the resume data to form the predefined resume format.

At block 70, the portable resume system enables the generated resume to be transmitted to at least one destination. For example, the destination may be an online job database that collects resumes and enables users to search for open jobs at a plurality of different companies. Alternatively, the destination may be an employer or to an employer's job server. It should be appreciated that the resume may be transmitted to any desired destination. At block 80, the portable resume system enables any destination that received the resume to obtain any updates the user makes to the resume. In one embodiment, the user can cause the resume updates to be transmitted to any of the destinations that received the resume. Alternatively, at least one of the destinations can request or check for any resume updates for the received resume.

It should be appreciated that the terms such as “user's credentials or attributes”, “user data”, “resume data”, “data” are used herein interchangeably to describe a collection of a job seeker's resume information, skills, desires, or any other suitable data that can be collected, stored, and made available for the portable resume system.

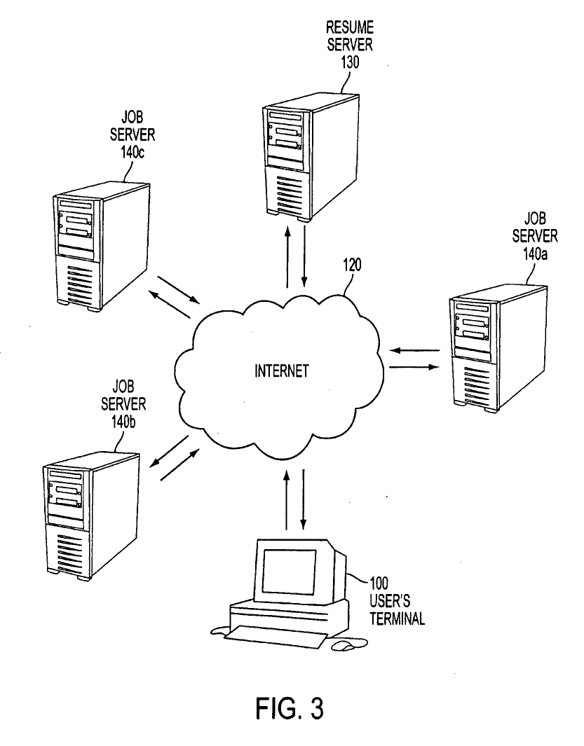

FIG. 3 illustrates one embodiment of a portable resume system that provides a streamlined process for a user to maintain, distribute, and update the user's resume data in the standardized resume language. In one embodiment, the portable resume system includes at least one user terminal 100, at least one resume server 130, and a plurality of job servers 140a-140c that communicate through at least one network 120 (e.g., the Internet or any other suitable network). In one embodiment, user terminal 100 captures a user's (e.g., a job seeker or other suitable entity that requires a resume) resume data at least partially in a standardized resume language and uploads the resume data to resume server 130. Resume server 130 stores the uploaded resume data and can generate a resume in a predefined format based on the uploaded resume data. Resume server 130 also makes the user's resume data available or transmits the generated resume in the predefined resume format to at least one or more of the job servers 140a-140c without requiring the user to create a resume specific to any of the job servers 140a-140c or participate in any required registration process that would have captured the same or similar information. If the user modifies any of the resume data associated with the user or adds new resume data to the user's data stored in resume server 130, resume server 130 allows any of the job servers 140a-140c to obtain the resume data updates associated with the user without requiring the user to contact each of the jobs servers individually to update the resume data stored at job servers 140a-140c. It should be appreciated that the portable resume system can include any suitable hardware in any suitable quantity to perform the functions of the portable resume system. It should also be appreciated that any one of the user terminal 100, resume server 130, and job servers 140a-140c can perform at least one or all of the functions of the portable resume system.

Resume server 130 is configured to collect and store resume data from at least one user terminal such as user terminal 100 in one embodiment. Resume server 130 is also configured to generate at least one resume in a predefined resume format based on the collected resume data from the at least one user. Resume server 130 is further configured to transmit the generated at least one resume in the predefined resume format to at least one destination such as job servers 140a-140c or at least one destination (e.g., a potential employer, an individual, or any other entity that may desire to receive resumes of potential employees). It should also be appreciated that resume server 130 can transmit a user's stored data without generating a resume in the predefined format.

Collected resume data may include the user's employment history such as a description of at least one previously held or present job. Resume data may also include the user's contact information, education, hobbies, and any other data suitable for creating a resume. In one embodiment, resume server 130 includes software that allows the user to complete a skills interview to facilitate the collection of resume data. The skills interview may involve asking the user to provide job requirements information. For example, the user can provide information such the type of job desired, salary requirements, travel limitations, experience or any other suitable and/or relevant information. In one embodiment, the skills interview may include one or more of the question and answer processes as described in U.S. patent application Ser. No. 11/331,672, entitled “MATCH-BASED EMPLOYMENT SYSTEM AND METHOD”, filed Jan. 13, 2006, the entire contents of which are hereby incorporated by reference for the purposes of the data collection discussion. However, it should be appreciated that data can be collected from the user in any suitable manner.

In one embodiment, at least some of the collected resume data is captured and stored in a standardized resume language. In one such embodiment, resume server 130 generates predefined employment descriptions for the user to select from so that the user provides employment history in a standardized resume language to resume server 130. For example, if the user is a software programmer, the user selects from a provided list of professions (e.g., a drop down list) that best describes the user's profession as a software programmer. Thus, a profession that is associated with a user can be standardized to eliminate misspellings or terminology variations that occur when different people describe the same or similar employment experiences. It should be appreciated that resume server 130 can provide standardized descriptions for any of the collected resume data.

In an alternative embodiment, at least one standardized description for resume data can be mapped to a plurality of terminology variations of the at least one standardized description. In one such embodiment, resume server 130 can provide the plurality of terminology variations of the at least one standardized description for the user to select from, but selecting from one of the terminology variations will still result in the selection of the standardized description. For example, different terms for a profession can describe the same or equivalent employment experience (e.g., software programmer, software developer, applications programmer). These terms for the profession can be associated with or mapped to a single profession (e.g., software programmer) because they are the same or equivalent jobs. In one such example, resume server 130 generates a list of a plurality of the terms for a profession for the user to select from including software programmer, software developer, applications programmer. These different terms for the profession are mapped to the term software programmer. Thus, if the user selected the profession “developer” instead of the job title “software programmer”, the resume server 130 records the user's selection as “software programmer.”

It should be appreciated that at least some of the collected resume data may not be standardized (i.e., predefined) using the standard resume language. That is, resume server 130 is configured to collect and store a user's free form data entry (i.e., the user's entries are not selected from a list, but may be entered in a text box or in any other suitable manner). For example, resume server 130 can collect a user's contact information by allowing a user to type the user's home address or phone number. In an alternative example, resume server 130 may not have a standardized description for every possible profession. Thus, resume server 130 can be configured to collect the user's own profession description for the user's resume data (e.g., typed submission). In one embodiment, resume server 130 can be configured to collect any or all of the resume data using the user's own descriptions rather than predefined or standardized selections.

In one embodiment, resume server 130 can be configured to accept a user's resume as a full or partial document in the predefined resume format at least partially in lieu of collecting the user's resume data through individual entries and selections as described above (e.g., through the skills interview). That is, resume server 130 can accept a resume in the predefined resume format that was created from another source as an alternative way to collect the user's resume data. Thus, based on the predefined resume format, resume server 130 can receive and accurately parse/store the user's resume data from the user's existing resume in the predefined resume format.

In an alternative embodiment, resume server 130 can be configured to accept a user's resume as a full or partial document that is not in the predefined resume format as a basis to generate a resume in the predefined resume format. That is, if the user already has a resume in a format other than the predefined resume format, the user can transmit this preexisting resume to resume server 130 (e.g., a resume created by the user in the user's selected format or created by the user through an alternative resume generation program). In this embodiment, resume server 130 can receive, parse, and store the user's resume data to the degree possible. Due to potential parsing errors, resume server 130 can be configured to allow a user to correct or update any parsing errors resulting from the parsed resume that is not in the predefined resume format. In one such embodiment, the resume server 130 will provide a skills interview to supplement any collected data, as previously discussed above.

Resume server 130 includes at least one software application for collecting the user's resume data. In one embodiment, resume server 130 collects resume data from the user through a web browser based software application. In one such embodiment, resume server 130 generates one or more user accessible web pages that allow a user to transmit resume data to resume server 130 (e.g., such web pages may execute the skills interview described above or facilitate resume data collection in any suitable manner). The web pages used to capture the user's resume data can be developed using any suitable web development language such as HTML, ASP, JAVA, Javascript, Perl, PHP, and AJAX; however it should be appreciated that any suitable programming language can be used develop software to capture the user's resume data.

In an alternative embodiment, resume server 130 does not use a web browser based software application to collect the user's resume data. In one such embodiment, resume server 130 includes at least one software application that is configured to receive resume data through an application programming interface from a locally based software application running on a computer (e.g., user terminal 100). The software application used to capture the user's resume data can be developed using any suitable development language such as C, C++, or JAVA; however it should be appreciated that any suitable programming language can be used develop the software application to capture the user's resume data.

In one embodiment, resume server 130 is in communication with at least one resume database to store the user's resume data. Resume server 130 can be in communication with the resume database via at least one network (e.g. a local network or the Internet), or via a direct coupling/integration with resume server 130 (e.g., a hard drive coupled via SATA or any other suitable interface to a motherboard in resume server 130).

In one embodiment, resume server 130 is configured to provide access (read/write access) to at least some or all of the resume data collected from the user to different destinations through an application programming interface (API). For example, an ATS or a online job database can be programmed with software to interface with the API of resume server 130 to selectively obtain portions of the user's data (e.g., the user's employment history) or all of the data collected from the user. The API also enables the ATS or the online job database to obtain any additions, updates, or changes to the user's data. Thus, in one embodiment, resume server 130 does not need to generate and transmit a resume in the predetermined resume format because destinations can obtain the user's data directly through the API. It should be appreciated that the API can provide access to any other suitable functionality of resume server 130. In one such embodiment, the API of resume server 130 can be configured to enable a destination to request that resume server 130 generate a resume in the predefined resume format based on at least one user's stored data and transmit the generated resume to the destination (or alternatively, to a destination different from the requesting destination).

In one embodiment, resume server 130 is configured to generate at least one resume in at least one predefined resume format based on at least some of the resume data collected from the user. In one such embodiment, resume server 130 can be configured with a structure for a predefined resume format based on the extensible markup language (XML) standard. For example, when requested, resume server 130 can generate a resume in the predefined resume format by retrieving the user's resume data stored in a resume database and organize the user's resume data into at least one data file based on the predefined resume format, wherein specific portions of resume data are associated with a predefined XML tag. Thus, if the generated resume in the predefined resume format is sent to another computer system configured to parse the predefined resume format, the computer system can accurately process and store the resume data in the generated resume without parsing errors (e.g., the computer system receiving the generated resume can determine what resume data in the generated resume relates to a prior employment description versus contact information).

Resume server 130 allows at least one destination that received a user's resume data to obtain any updates to the user's resume data. In one embodiment, updates are only new or modified portions of the user's resume data. However, in an alternative embodiment, updates to the user's resume data may include providing access to the updated resume data or a newly generated resume in the predefined resume format having the previous resume data and any new or modified resume data. In one embodiment, resume server 130 transmits or “pushes” any updates to the user's resume data to at least one or all destinations that received the user's resume data. In one embodiment, resume server 130 automatically transmits the updates without additional user intervention. In an alternative embodiment, resume server 130 does not transmit the updates unless the user takes positive steps to request that the updates are distributed to at least one or all destinations that received the user's resume data. In one embodiment, resume server 130 allows at least one destination that received the user's resume data to request any updates to the user's resume data. That is, the destination initiates the request or “pulls” the updates. It should be appreciated that resume server 130 allows a user to selectively control which destination can obtain updates to the user's resume data as well as control what updates are provided to certain destinations.

Resume server 130 can publish a user's data or the user's generated resume in the predefined resume format over at least one network in one embodiment. For example, resume server 130 can publish the user's data or resume as a webpage for viewing in a web browser over the Internet. In one such embodiment, resume server 130 provides the user a link to the user's webpage that includes the resume, whereby the user can share the webpage with at least one person or system. The webpage may further include a link to download the user's data or resume in the in the predefined resume format.

In one embodiment, resume server 130 includes account security that is associated with the user. For example, if resume server 130 collects resume data for a user, the user's account is protected by at least a username and password. Thus, in one embodiment, a user account is created and the user's resume data and generated resume are not accessible without providing resume server 130 the appropriate username and password combination. It should be appreciated that any suitable data protection scheme can be used to secure the user's resume data. Alternatively, a user account may have no security. Account security can additionally include different levels (or any suitable level) of control over the user's resume data. For example, resume server 130 allows the user to have full access (e.g., read/write access) to the user's resume data, but only partial access (e.g., read only access) to third parties that the user allows to access the user's resume data.

In one embodiment, the portable resume system may include a plurality of resume servers like resume server 130. For example, the portable resume system may require a plurality of resume servers to handle a large number of users distributing resume data or resumes in the predefined resume format (i.e., for load balancing). In an alternative embodiment, the portable resume system may include a plurality of resume servers wherein at least one resume server can be dedicated to collecting and generating resumes for a specific a profession or type of user.

In one embodiment, resume server 130 is a computer server. In one embodiment, resume server 130 is a standalone computer server that only performs functions of the resume server 130 as describe herein. In an alternative embodiment, resume server 130 can be configured to perform alternative functions in addition to the resume server functions described herein. Thus, it should be appreciated that resume server 130 can be any other suitable computing device such as a desktop computer, a laptop, a cell phone, a portable digital assistant, a slim terminal computer, or a kiosk that can run software and/or hardware to interoperate with the portable resume system and execute the desired resume server functions.

In one embodiment, user terminal 100 is configured collect a user's resume data. User terminal 100 is also configured to transmit the collected resume data to at least one destination such as resume server 130 or job servers 140a-140c.

In one embodiment, user terminal 100 includes at least one web browser that enables a user to interface with resume server 130. In one such embodiment, user terminal 100 loads a web browser based software application from resume server 130 that allows user terminal 100 to collect resume data in the standardized resume language (using the data collection techniques described above or any other suitable data collection techniques) and transmit the resume data back to resume server 130 for storage. In an alternative embodiment, user terminal 100 includes at least one desktop software application that collects the user's resume data (i.e., the software application allows user terminal 100 to collect the user's resume data offline before it is sent to resume server 130). In this embodiment, user terminal 100 transmits the user's resume data (using at least one of any suitable communication protocols) to resume server 130 for storage after any suitable amount of resume data is captured with the desktop software. In one embodiment, user terminal 100 can be configured to operate with both the desktop software and the web based software jointly to collect the user's resume data and transmit the user's data to resume server 130 for storage.

In one alternative embodiment, user terminal 100 includes software that performs at least some of the functions of resume server 130. For example, in addition to collecting the user's resume data, user terminal can be configured to generate a resume in the predefined resume format. User terminal 100 can also be configured to transmit the resume data or generated resume in the predefined resume format to at least one destination such as resume server 130. In one such embodiment, user terminal 100 provides the user's data or the generated resume in the predefined resume format to resume server 130 through the resume server 130's API. User terminal 100 can also be configured to transmit the generated resume in the predefined resume format directly to job servers 140a-140c, to a potential employer via email, or to any other suitable destination in any suitable manner. In one alternative embodiment, user terminal 100 includes all of the functions of the resume server 130.

In one embodiment, user terminal 100 is a personal computer capable of network communication. It should be appreciated that user terminal 100 can be any suitable terminal such as a desktop computer, a laptop, a server, a cell phone, a portable digital assistant, a slim terminal computer, or a kiosk that can run software and/or hardware to interoperate with the portable resume system and execute the desired user terminal functions.

Job servers 140a-140c are configured to, among other things, obtain, parse, and store at least one user's resume in the predefined resume format or obtain a user's resume data in another manner such as through resume server 130's API. Job servers 140a-140c are destinations such as ATSs, online job databases (e.g., JobFox.com™, Monster.com™), proprietary employer or recruiter job databases (e.g., USAJOBS.com™), social networking systems (Linkedin.com™, Facebook.com™), or any other suitable destination that may require access to the user's data.

In one embodiment, if job servers 140a-140c receive at least one resume in the predefined resume format, job servers 140a-140c accurately parse and store all of the resume data from the received at least one resume. For example, if the predefined resume format identifies resume data as a profession, when job servers 140a-140c parse a received resume in the predefined resume format, job servers 140a-140c can accurately identify any resume data tagged as a profession and appropriately store such resume data. It should be appreciated that job servers 140a-140c can also receive, parse, and store resumes in any format in any suitable manner (e.g., formats other than the predefined resume format).

In one embodiment, job servers 140a-140c are configured to receive at least one resume in the predefined resume format or at least one user's resume data without initiating or requesting the transmission of the at least one resume. That is, a source of the resume, such as resume server 130 or user terminal 100, initiates the resume data transmission and “pushes” the resume data to the job servers 140a-140c. In one embodiment, job servers 140a-140c may be configured with an API (as described above) that enables resume server 130, user terminal 100, or any other suitable device to provide the resume data to job servers 140a-140c. In an alternative embodiment, job servers 140a-140c are configured to receive at least one resume in the predefined resume format or at least one user's resume data from a source based on a request initiated by job servers 140a-140c. That is, job servers 140a-140c are configured to request transmission of the resume data and “pull” the resume data to the job servers 140a-140c. In one such example, a company job website indicates that the company's job website interoperates with the portable resume system (i.e., accepts resumes in the predefined resume format or can obtain resume data through the API). The company's job website server allows a user to provide the location and account access information to a resume server that stores the user's resume data. The website server then contacts the provided resume server and pulls the user's resume data from the provided resume server. It should be appreciated that the user's resume data can include a generated resume in the predefined resume format. It should also be appreciated that the user can provide the user's resume data to the company's job website server in any suitable manner (e.g., using the push or pull methods previously described). In one embodiment, job servers 140a-140c may require a user to have or create a user account to store resume data associated with the user. In one such embodiment, the portable resume system enables job servers 140a-140c to automatically create an account for the user based in part on any received resume data. It should be appreciated that an account can be created on job server 140a-140c in any suitable manner.

In one embodiment, job servers 140a-140c are configured to obtain and store updates to any received resume data. In one embodiment, job servers 140a-140c query the source (e.g., resume server 130) of the received resume data to check for any additions or changes to the received resume data (i.e., the job servers pull the resume data updates to keep the any previously received resume data up-to-date). Job servers 140a-140c can query the source automatically, such as at predetermined intervals of times. Job servers 140a-140c can also query the source based on a manual request. For example, if an employer was reviewing a user's resume data received at job server 140a, the employer can request that job server 140a query the source of the resume data for any additions or changes to the data. In one embodiment, job servers 140a-140c receive updates to any received resume data without querying (requesting) such updates (i.e., the job servers rely on a push method to keep any received resumes up-to-date). For example, resume server 130, user terminal 100, or any other suitable source may transmit updates associated with the resume data to job servers 140a-140c when at least one update is made to stored resume data associated with at least one user.

In one embodiment, job servers 140a-140c allow requirements for open jobs to be written in the standardized resume language. Job servers 140a-140c can capture requirements for open jobs in a manner similar to the manner used to capture a user's resume data as described above (e.g., through a question and answer process or any other suitable manner). It should be appreciated that the requirements for open jobs can be captured in any suitable manner. Based on resume data stored in the standardized resume language and requirements for open jobs written in the same standardized resume language, job servers 140a-140c can be configured to compare at least one user's resume data to at least one open job for potential matching data. In one embodiment, job servers 140a-140c compare a user's resume data to at least one open job that is stored in job servers 140a-140c. In an alternative embodiment, job servers 140a-140c compare a user's resume data to at least one open job that is retrieved from at least one job database not stored in job servers 140a-140c. If the requirements for the at least one open job are written using the standardized resume language, job servers 140a-140c can accurately determine a degree of matching between the open job and the at least one user's resume data. That is, the matching results between the open job requirements and the resume data can be exact where the standardized resume language was used to define at least a portion of the open job requirements and a portion of the resume data. It should be appreciated that jobs and resumes can be matched in any suitable manner. For example, matches can be determined as described in U.S. patent application Ser. No. 11/331,672, entitled “MATCH-BASED EMPLOYMENT SYSTEM AND METHOD”, filed Jan. 13, 2006, the entire contents of which are hereby incorporated by reference for the discussion on creating matches. Job servers 140a-140c can be configured to notify the user of potential matches in any suitable manner such as emailing or sending a text message to the user.

In one embodiment, job servers 140a-140c allow requirements for at least one open job to be written based on an alternative predefined resume language (i.e., a resume language that is different from the standardized resume language). In one such embodiment, job servers 140a-140c are configured to associate or map the alternative predefined resume language to the standardized resume language to facilitate accurate comparisons between the at least one open job and the resume. For example, if the standardized resume language defines a profession as software programmer and the first set of defined job requirements defines the same profession as an “application developer,” job servers 140a-140c are configured to convert either “application developer” into “software programmer” or vise versa. Thus, where mapping is employed, job servers 140a-140c can continue to match open jobs to resume data with the normalized terms and achieve the same level of accuracy where the resume and the requirements for the open job were created using the same standardized resume language.

In one embodiment, job servers 140a-140c may be associated with only one company. In an alternative embodiment, job servers 140a-140c may be associated with a plurality of companies.

In one embodiment, job servers 140a-140c are computer servers capable of network communication. In one embodiment, job servers 140a-140c are standalone computer servers that only perform functions of the job servers 140a-140c as described herein. In an alternative embodiment, job servers 140a-140c can be configured to perform alternative functions in addition to the job server functions described herein. It should be appreciated that job servers 140a-140c can be any suitable computing device such as a desktop computer, a laptop, a cell phone, a portable digital assistant, a slim terminal computer, or a kiosk that can run software and/or hardware to interoperate with the portable resume system and execute the desired job server functions.

It should be appreciated that the portable resume system allows a user to simultaneously apply to a plurality of jobs at one or more companies or one or more job websites. The portable resume system uses the resume data in the standardized resume language to allow the user and/or at least one company to know instantly or within any suitable time frame, which jobs among numerous job openings at a company (or plurality of companies and/or job boards) are the best or a suitable fit to the user or the company.

The portable resume system also enables a user to be considered for at least one of a plurality of other jobs at a company without taking positive steps to apply to the plurality of other jobs at the company. For example, if the user applies once to a company for one specific open job, the company's job server (such as job servers 140a-140c) compares the user's resume data to job requirements of other jobs, effectively applying the user to a plurality of or all of the open jobs without having to individually apply to each of the plurality of open jobs. Thus, the portable resume system enables the user to apply to one job but be considered for at least one of a plurality of different jobs that the user may not have thought to consider or even knew to consider. It should be appreciated that the user may not want to be considered for one or more alternative open jobs, thus the user may restrict the user's resume from being considered and matched to at least one alternative open job at the company to which the user did not apply.

The portable resume system can also keep a user informed of new job opportunities that become available after the user has applied to at least one job at a company. For example, the user provides the user's resume data in the standardized resume language to a company to apply for a specific job. If the company stores the user's resume data for some predetermined amount of time in the company's job server, when new job opportunities are created at the company, the company can match the new job opportunities to the user's stored resume data in the company's job server. This can occur regardless of whether the user was hired for the specific job. As the user's resume data stored at the company's job server can be kept up-to-date using the push or pull method described above, the company can also potentially match the user to new job opportunities that reflect additional experience the user gains over time.

The portable resume system also allows the user to transmit the user's resume data in the standardized resume language to a destination that does not have equipment to fully or partially interoperate with the portable resume system. For example, the destination may be a small business owner or a corporation that does not use job servers (e.g., job servers 140a-140c or other types of servers) that parse and match resume data with open jobs. In one such embodiment, the portable resume system allows the user to transmit a generated resume in the predefined resume format (using the standardized resume language) to such a destination. The resume can be transmitted in any suitable manner (e.g., via email to the destination). If the user modifies any of the resume data or adds new resume data to the user's stored resume data, the portable resume system can be configured to provide an updated resume to the destination or allow the destination to access the updated resume data in the other suitable manners (e.g., through a website as described above). In one example, the portable resume system can transmit a full resume with the updates via email to the destination.

It should be appreciated that job seekers want to have their resume data submitted or posted with as many companies and job boards as possible. Until now, it was too difficult and time consuming for a job seeker to provide and maintain a resume or resume data with numerous companies and job boards because the job seeker had to apply to each job site or company individually and suffer through similar registration processes at each destination. However, the portable resume system greatly decreases a job-seeker's time and effort to apply to different jobs by providing users a way to share resume data in a standardized resume language and/or a predefined resume format that includes the standardized resume language. The uniformity of the standardized resume language and the interoperability of systems designed to handle the portable resume system eliminates the requirement that the job seeker fill-out an individual application form at every employer website or recreate a resume at each job board or job website. Reducing the number of steps in the job application or resume posting process reduces the chance that a job seeker will abandon posting a resume or resume data on a job board. Thus, candidate submission and completion rates on job boards and at company job servers are significantly increased. The uniformity of the predefined resume format also enables companies and job boards to obtain highly accurate matching between open jobs and qualified candidates. Creating highly accurate matches saves time and money such as cost savings on job board expenditures and time devoted to finding resumes that have the best fit to open jobs.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A portable resume system comprising:
at least one terminal in communication with at least one network; and
at least one resume server in communication with the at least one network and configured to store resume data,
wherein the at least one terminal and the at least one resume server are configured to communicate over the at least one network to:
(i) capture a plurality of resume data at least partially in a standardized resume language for at least one user at the at least one terminal,
(ii) upload the captured plurality of resume data to the resume server, and
(iii) store the uploaded plurality of resume data in a database in communication with the resume server.

2. The system of claim 1, wherein the at least one terminal and the at least one resume server are configured to enable at least one destination to obtain and store the stored resume data.

3. The system of claim 2, wherein the at least one destination includes at least one job server configured to pull the stored resume data.

4. The system of claim 2, wherein the resume server is configured to push the generated resume to the at least one destination.

5. The system of claim 3, wherein the at least destination job server maps at least a portion of the stored resume data to at least a portion of the at least one destination's predefined resume language.

6. The system of claim 3, wherein if the user modifies any of the stored resume data or adds new resume data, enable the destination job server to obtain and store the updated or new resume data.

7. The system of claim 6, wherein the resume server pushes the new or updated resume data to the destination job server.

8. The system of claim 6, wherein the destination job server pulls the new or updated resume data from the resume server.

9. The system of claim 3, wherein if the at least one destination job server obtains the stored resume data as an application for a first job opening, the at least one destination job server automatically compares the obtained resume data to at least one different job opening.

10. The system of claim 1, wherein the at least one user terminal generates a resume in the predefined resume format based at least in part on the captured resume data.

11. The system of claim 1, wherein the at least one resume server generates a resume in the predefined resume format based at least in part on the captured resume data.

12. A method for distributing a portable resume comprising:
(a) capturing a plurality of resume data in a standardized resume language for at least one user with at least one terminal that is in communication with at least one network;
(b) uploading the captured plurality of resume data to a resume server that is in communication with the at least one network; and
(c) storing the uploaded plurality of resume data in the resume server.

13. The method of claim 12, further comprising providing at least one destination access to the stored resume data.

14. The method of claim 13, further comprising storing any obtained resume data based on the predefined resume format in at least one destination job server.

15. The method of claim 14, further comprising translating at least a portion of the obtained resume data stored in the at least one destination job server to a second predefined resume format used by the at least one destination job server based on a data mapping between resume data in the predefined resume format and the second predefined resume format.

16. The method of claim 14, further enabling the at least one destination job server to obtain any newly added or updated resume data.

17. The method of claim 16, further comprising the resume server pushing the new or updated resume data to the destination job server.

18. The method of claim 16, further comprising the destination job server pulling the new or updated resume data from the resume server.

19. The method of claim 13, wherein if the destination job server obtains the resume data for the at least one user as an application for a first job opening, further comprising automatically comparing the resume data to at least one different job opening.

20. The method of claim 12, further comprising generating a resume in a predefined resume format based at least in part on the stored resume data.
